(19) United States
(12) Patent Application Publication
(10) Pub. No.: US 2017/0054592 A1
(43) Pub. Date: Feb. 23, 2017

(54) ALLOCATION OF CLOUD COMPUTING RESOURCES

(71) Applicant: TELEFONAKTIEBOLAGET LM ERICSSON (PUBL), Stockholm (SE)

(72) Inventor: Christian OLROG, Stockholm (SE)

(73) Assignee: TELEFONAKTIEBOLAGET LM ERICSSON (PUBL), Stockholm (SE)

(21) Appl. No.: 15/307,625

(22) PCT Filed: Apr. 30, 2014
(86) PCT No.: PCT/SE2014/050539

§ 371 Date: Oct. 28, 2016

(51) Int. Cl. H04L 12/24; H04L 12/927; H04L 12/911; G06F 11/20

(52) U.S. Cl. CPC H04L 41/0668; G06F 11/203; H04L 41/5016; H04L 47/805; H04L 47/803; H04L 47/746; G06F 2201/805; G06F 2201/82; H04L 67/10

(57) ABSTRACT

The invention concerns a method, arrangement (26), computer program and a computer program product for allocating physical cloud computing resources (12, 16, 18) to processes, where at least some of the cloud computing resources (12, 16, 18) have different ages, said cloud computing resources (12, 16, 18) having individual primary failure probabilities, each being based on an age dependent failure probability function of the cloud computing resource. The receives requests for performing computational tasks for a number of processes, where the processes have different process priorities, investigates the availability of the cloud computing resources for performing the tasks of the requests, and assigns the available cloud computing resources to the based on the process priorities, where processes with the highest process priorities are assigned to the cloud computing resources (12, 16, 18) having the lowest primary failure probabilities.

### TECHNICAL FIELD

The invention generally relates to cloud computing. More particularly, the invention relates to a method, arrangement, computer program and a computer program product for allocating physical cloud computing resources to processes.

### BACKGROUND

Data centre management has become increasingly important with the development of remote computing operations, such as so called cloud computing.

Huge data centres that perform computing operations for various applications have thus become common in later years.

In these situations various types of applications send processing requests to a such a datacentre, in which the processing of requests is performed and results are then delivered to the requesting device or network.

In datacentre management in general and in cloud setups in particular there is a function often referred to as a scheduler that assigns a specific workload to a specific hardware instance, i.e. assigns a processing task to a specific physical resource.

The scheduler is thus responsible for assigning hardware resources within a datacentre and these resources perform processing and send the results to a requesting computer or human. The requesting computer, which is running some type of process, does then not know or for that matter care which physical resource in the datacentre that performs the processing, but is only interested in the fact that it is done, where the processing in the datacentre being performed on a cloud computing resource may be a virtual machine. Furthermore, in this operation the processing of the tasks have to live up to some reliability requirements. The processing of a task being assigned by an application may be handled according to a service level agreement (SLA) specifying how reliable the processing of the tasks being assigned by the application needs to be. There may for instance be a mean time to repair MTTR or availability value associated with the agreement identifying the reliability required by the datacentre in the processing of the tasks of the applications.

For such a datacentre there may therefore be a number of different availability rates that need to be fulfilled. One application may for instance require an availability of 99.999%, another an availability of 99.99% and a further may require an availability of 99.9%.

For a datacentre performing cloud computing it is therefore of interest to be able to meet the various requirements. However, this may need to be combined with an efficient use of the physical resources.

There is therefore a need for a way of a cloud computing datacentre to be able to meet the various availability rates required by various applications while at the same time using the physical resources in an efficient manner.

### SUMMARY

One object of the invention is thus to assign cloud computing resources to processes and combine the meeting of availability rate requirements by various applications while at the same time using the physical resources in an efficient manner.

This object is according to a first aspect achieved by an arrangement for allocating physical cloud computing resources to processes. At least some of the cloud computing resources have different ages. They also have individual primary failure probabilities, each being based on an age dependent failure probability function of the cloud computing resource. The arrangement comprised a processor acting on computer instructions whereby the arrangement is operative to

receive requests for performing computational tasks for a number of processes, the processes having different process priorities,
investigate the availability of the cloud computing resources for performing the tasks of the requests, and
assign the available cloud computing resources to the processes based on the process priorities, where processes with the highest process priorities are assigned to the cloud computing resources having the lowest primary failure probabilities.

This object is according to a second aspect also achieved by a method for allocating physical cloud computing resources to processes. At least some of the cloud computing resources have different ages. They also have individual primary failure probabilities, each being based on an age dependent failure probability function of the cloud computing resource. The method is performed in a cloud computing resource allocating arrangement and comprises

receiving requests for performing computational tasks for a number of processes, the processes having different process priorities,
investigating the availability of the cloud computing resources for performing the tasks of the requests, and
assigning the available cloud computing resources to the processes based on the process priorities, where processes with the highest process priorities are assigned to the cloud computing resources having the lowest primary failure probabilities.

The object is according to a third aspect achieved through a computer program for allocating physical cloud computing resources to processes. At least some of the cloud computing resources have different ages. The cloud computing resources also have individual primary failure probabilities, each being based on an age dependent failure probability function of the cloud computing resource. The computer program comprises computer program code which when run in an arrangement for allocating cloud computing resources, causes the arrangement to:

receive requests for performing computational tasks for a number of processes, the processes having different process priorities, investigate the availability of the cloud computing resources for performing the tasks of the requests, and
assign the available cloud computing resources to the processes based on the process priorities, where processes with the highest process priorities are assigned to the cloud computing resources having the lowest primary failure probabilities.

The object is according to a fourth aspect achieved through a computer program product for allocating physical cloud computing resources to processes. The computer program product comprises a data carrier with computer program code according to the third aspect.

The invention according to the above-mentioned aspects has a number of advantages. It combines the fulfilling of availability requirements with the efficient usage of cloud computing resources. In this way the risk of failing to meet contractual obligations is lowered combined with a good usage of equipment, which may be advantageous from a maintenance point of view.

In an advantageous variation of the first aspect, the arrangement is further configured to determine the primary failure probability of each cloud computing resource based on the age and the failure probability function. In a corresponding variation of the second aspect, the method further comprises determining the primary failure probability of each cloud computing resource based on the age and the failure probability function.

At least some of the cloud computing resources may further employ auxiliary resources for their performing of computational tasks.

According to another variation of the first aspect, the arrangement is further configured to consider secondary failure probabilities of used auxiliary resources in determining the primary failure probability of a cloud computing resource.

According to a corresponding variation of the second aspect, the method further comprises considering secondary failure probabilities of used auxiliary resources in the determining of the primary failure probability of a cloud computing resource.

The primary failure probability of a cloud computing resource may be based on the degree of utilization of the cloud computing resource.

According to a further variation of the first aspect, the arrangement is further configured to query auxiliary resources of the degree of utilization by a cloud computing resource and estimate the degree of utilization based on the response.

According to a corresponding variation of the second aspect, the method further comprises querying auxiliary resources of the degree of utilization by a cloud computing resource and estimating the degree of utilization based on the response.

According to yet another variation of the first aspect, the arrangement is further configured to query a cloud computing resource about data indicative of the utilization and estimate the degree of utilization based on the response.

According to a corresponding variation of the second aspect, the method further comprises querying a cloud computing resource about data indicative of the utilization and estimating the degree of utilization based on the response.

According to yet a further variation of the first aspect, the arrangement is further configured to query an external management system and estimate the degree of utilisation based on the response.

According to a corresponding variation of the second aspect, the method further comprises querying an external management system and estimating the degree of utilisation based on the response.

The primary failure probability of a cloud computing resource may also be based on the physical environment of the cloud computing resource.

The primary failure probability of a cloud computing resource may furthermore be based on fault and error data associated with the cloud computing resource.

The primary failure probability of a cloud computing resource may also be based on fault and error data of a requesting process

According to another variation of the first aspect, the arrangement is further configured to assign a single cloud computing resource having the highest primary faulty probability to the requesting process having the lowest process priority.

According to a corresponding variation of the second aspect, the method further comprises assigning a single computational resource having the highest faulty probability to the requesting process having the lowest process priority.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a number of processes communicating with a cloud computing datacentre,

FIG. 2 schematically shows the cloud computing data centre comprising a number of physical cloud computing resources and auxiliary resources employed by some of the cloud computing resources,

FIG. 3 shows a block schematic of a first way of realizing a cloud computing resource allocation arrangement in the cloud computing datacentre,

FIG. 4 shows a block schematic of a second way of realizing the cloud computing resource allocation arrangement,

FIG. 5 shows a flow chart of method steps in a method for allocating physical cloud computing resources according to a first embodiment,

FIG. 6 shows a flow chart of method steps in a method for allocating physical cloud computing resources according to a second embodiment,

FIG. 7, schematically shows a number of method steps being performed by the cloud computing resource allocation arrangement for determining primary fault probabilities associated with the cloud computing resources, and

FIG. 8 shows a computer program product comprising a data carrier with computer program code for implementing the functionality of the cloud computing resource allocation arrangement.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known arrangements, devices, circuits and methods are omitted so as not to obscure the description of the invention with unnecessary detail.

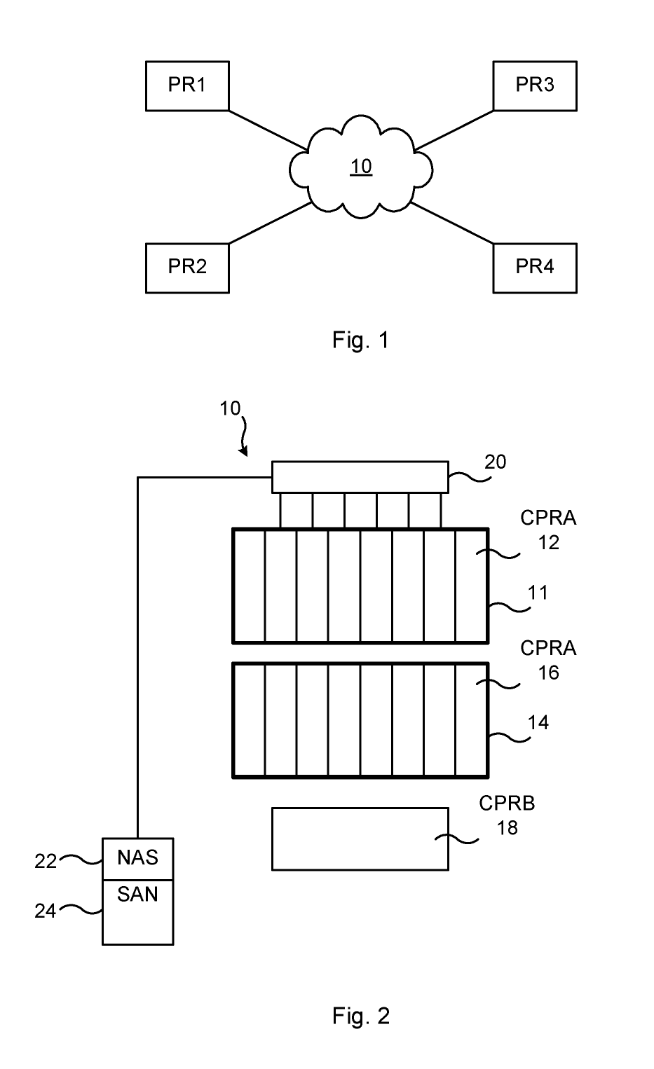

FIG. 1 schematically shows a datacentre 10, which may be a cloud computing datacentre, to which various processes send processing tasks that the data centre is to complete. A task may as an alternative be sent be by a human. The processing task may also involve implementing a virtual machine in the datacentre 10. As an example there is a first process PR₁, a second process PR₂, a third process PR₃ and a fourth process PR₄ sending tasks to the datacentre 10. The first process may as an example be a voice media handling process, and the second process PR₂ may be a batch data handling process. These processes may furthermore have different requirements on the availability of the datacentre in the handling of tasks they assign, where the availability requirements may be set out in so called Service Level Agreements (SLAs). Therefore the different processes may in the view of the datacentre with advantage have different process priorities, where a high priority has a high availability requirement and a low priority a lower availability requirement. The priorities are business priorities and not operational priorities. They are thus not priorities reflecting the order in which tasks are to be handled, but priorities used for meeting the availability stipulated in an agreement. The availability requirements may as an example be set out as percentages. The first application PR₁ may for instance require an availability of 99.999%, the second PR₂ an availability of 99.99%, the third PR₃ also an availability of 99.99% and the fourth PR₄ an availability of 99.9%. In this case the first process PR₁ has the highest priority, the second and third processes PR₂ and PR₃ have shared second highest priorities and the fourth process PR₄ the lowest priority. Furthermore, the SLAs may also set out how sensitive to security the processing is. This security sensitiveness may also be reflected in the process priority.

FIG. 2 schematically shows various cloud computing resources in the datacentre 10 together with auxiliary resources. A cloud computing resource may here be a so-called processing blade which is based on a processor and local solid state disk (SSD) combination. A processing blade may as an example comprise one or two processors and one or two hard disks such as one or two SSD disk. Such a processing blade is here a first type of cloud computing resource CPRA and may be provided in a processing blade cabinet or chassis. In FIG. 2 there is a first cabinet or chassis ii with a number of processing blades CPRA, where one such cloud computing resource of the first type CPRA 12 is indicated. There is also a second cabinet or chassis 14 with a number of cloud computing resources of the first type, where a second CPRA 16 is indicated. The processing blades are all connected to a first auxiliary resource 20 in the form of a switch for being connected to other auxiliary resources. Although only the processing blades of the first cabinet 11 are shown as being connected to the switch 20, it should be realized that also the processing blades of the second cabinet 14 are connected to it. The other auxiliary resources comprise a Network Attached Storage (NAS) 22, which is an additional storage area for the processing performed by the cloud computing resources and a Storage Area Network SAN (24). Both these further auxiliary resources may be made up of further hard disks for performing processor operations. A SAN may as an example be made up of 50-100 hard disks. In the figure there is also shown a second type of cloud processing resource CPRB 18, which as opposed to the first type is a stand-alone resource, i.e. a cloud computing resource that is not combined with other cloud computing resources in a cabinet. This second type of resource is a so-called pizza box resource, comprising one or more processors, such as 1-4 CPUs and 8-10 hard disks. It does typically not use auxiliary resources such as SAN or NAS.

The resources may furthermore have different ages. The first cloud computing resource 12 of the first type may have been put into operation one year ago, the second cloud computing resource 16 of the first type may be totally new and just intended be started to be used. The cloud computing resource of the second type 18 may on the other hand have been in operation during for instance 5 years.

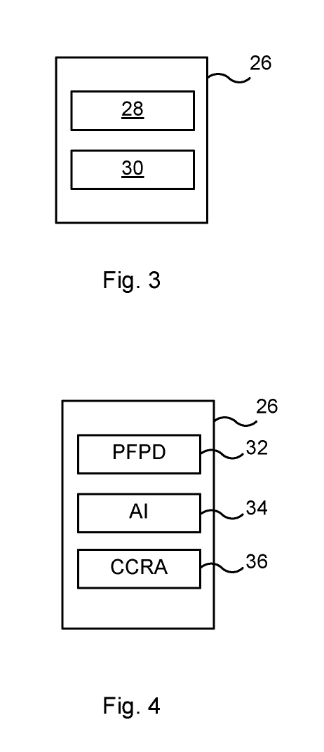

FIG. 3 shows a block schematic of a first way of realizing a cloud computing resource allocation arrangement 26. The cloud computing resource allocation arrangement 26 may be provided in the form of a processor 28 connected to a program memory M 30. The program memory 30 may comprise a number of computer instructions implementing the functionality of the cloud computing resource allocation arrangement 26 and the processor 28 implements this functionality when acting on these instructions. It can thus be seen that the combination of processor 28 and memory 30 provides the cloud computing resource allocation arrangement 26.

FIG. 4 shows a block schematic of a second way of realizing the cloud computing resource allocation arrangement 26. The cloud computing resource allocation arrangement 26 may comprise a primary fault probability determination unit PFPD 32, an availability investigating unit AI 34 and a cloud computing resource assigning unit CCRA 36.

The cloud computing resource allocation arrangement 26 may furthermore be implemented using some of the cloud computing resources, possibly together with auxiliary resources. The computer program code may for instance be stored on one of the SSD disks of a processing blade and provide the resource allocation arrangement when being run by a corresponding processor on the same processing blade. The arrangement may be stationary in that it is assigned to a fixed physical resource. Alternatively it is possible that it is mobile and moved from resource to resource, such as from processing blade to processing blade for instance based on reliability.

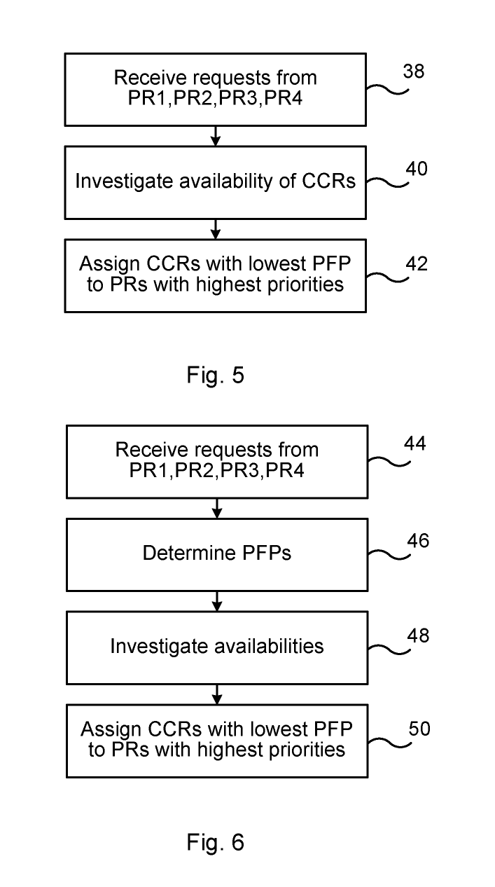

Now a first embodiment will be described with reference also being made to FIG. 5, which shows a flow chart of method steps in a method for allocating physical cloud computing resources being performed by the cloud computing resource allocation arrangement.

As mentioned earlier, it is today common that various types of processes, such as the processes PR₁, PR₂, PR₃ and PR₄ in FIG. 1, send processing requests regarding the performing of tasks to the datacentre 10, for instance the tasks of virtual machines. Theses requests are then assigned to different cloud computing resources where the tasks are performed. The entity in the datacentre that is responsible for selection of resource to perform such a task is then the cloud computing resource allocation arrangement 26.

The arrangement 26 may therefore also be considered to be a scheduler that assigns a specific workload to a specific hardware instance in the datacentre 10.

The scheduler or cloud computing resource allocation arrangement 26 is thus responsible for assigning hardware resources or cloud computing resources within the datacentre and these resources perform the processing or implement a virtual machine and send the possible results to a requesting entity, such as a computer. The requesting entity, which may be running some type of process, does then not know or for that matter care which physical resource in the datacentre performs that processing, but only that it is done. As an alternative, the requesting entity may be a human. In this operation the processing or virtual machine may have to live up to some reliability requirements. The processing of a task being assigned by an application may be made according to a service level agreement (SLA) specifying how reliable the processing assigned by the application needs to be. There may for instance be a mean time to repair MTTR or availability value associated with the agreement identifying the reliability required by the datacentre in processing the tasks of the applications.

For a datacentre performing cloud computing it is therefore of interest to be able to meet the various availability requirements, which is not so simple.

It is a well known fact that hardware has a failure probability distribution or fault probability function that varies with age, which is often termed a bathtub function because it is shaped as a bathtub or a U. This function, which is thus an age dependent failure probability function (FPF), has a failure probability that is high in beginning—low in the middle and increasingly higher at the end of the lifespan of the hardware. The function is used for obtaining a primary fault probability of the physical resource. Each cloud computing processing resource will thus receive a primary failure probability, which may be based on a Mean Time Between Failure (MTBF) value of the resource, i.e. a value of the above-described age dependent failure probability function.

However, also other factors may influence the primary fault probability of a cloud computing resource. It is for instance also known that temperature, dirt and humidity may have an adverse effect on hardware Mean Time Between Failure (MTBF) and for some components (e.g. solid state storage devices) active (reads/writes) or passive (percent of storage used) utilization may also directly impact MTBF. Thus, these may also be used to influence the primary fault probability of a physical resource.

As telecom and other critical solutions are brought to cloud technologies, it has been realized that certain applications are “more” critical than others. They thus have different priorities based on the availability requirements in their SLAs.

Aspects of the invention use some or all of the above-mentioned information in the determining of which resources to assign to a task or a virtual machine in order to fulfil the availability requirements stipulated in the SLAs covering the process that sends the request with the task as well as in order to obtain an efficient use of the processing resources without unnecessary replacement.

Aspects of the invention thus provide a way to balance the availability requirements of the processes with efficient use of the existing hardware.

The arrangement 26 therefore applies knowledge about hardware lifecycle as well as uses knowledge about application criticality when performing selection of hardware for an application.

The cloud computing resource allocation arrangement 26 uses the fact that in a datacentre there may be hardware in the form of physical cloud computing processing resources, where at least some have different ages, which means that they are in different stages of their lifecycle and hence have different reliabilities.

This knowledge is combined with knowledge about the required availability and used in the selection of which resources are to perform the tasks of the processes.

In order to perform the method according to the first embodiment, the cloud computing resource allocation arrangement 26 first receives requests for performing computational tasks for a number of processes, step 38. It may thus receive requests for processing from the first process PR₁, from the second process PR₂, from the third process PR₃ and from the fourth process PR₄. As mentioned earlier a request may be as an alternative be sent by a human. The handling of the processes are each covered by different SLAs setting out reliability requirements and therefore the processes have different priorities, where, as was mentioned earlier, the first process PR₁ may have the highest priority, the second and third process PR₂ and PR₃ share a second highest priority and the fourth process PR₄ may have a lowest priority. The processing requests may be received by the primary fault probability determining unit 32. As an alternative they may be received by the availability investigating unit 34. In this first embodiment they are received by the availability investigating unit 34.

The availability investigating unit 34 investigates the availability of the cloud computing resources for performing the tasks of the requests or virtual machines, step 40. This may involve investigating which of the cloud computing resources of either the first and/or the second type are busy and which are free to receive a task. This investigation may be performed through the availability investigating unit 34 querying the individual cloud computing resources and receiving responses from them. It may also be done through monitoring the activity of the processors of the resources with regard to processor load and determining that a processor is available if the processor load is below a processor load threshold.

The ones that are available may then be investigated with regard to primary fault probability. The primary fault probability determining unit 32 may have a register where the individual primary failure probabilities of the various resources are stored. In its simplest form the primary failure probability of a physical resource is only based on the age dependent failure probability function of this resource, i.e. the failure probability function that depends on the age of the resource. The primary fault probability determining unit 32 may thus determine the primary failure probability of each cloud computing resource based on the age and the failure probability function. The primary failure probability may thus be obtained through a value on the curve corresponding to the age. In other instances the primary failure probability may be obtained based on a number of further inputs as well. The value obtained from the age dependent failure probability function may for instance be adjusted based on the amount of operation of the resource, i.e. how much the resource has been used, the environment in which it is provided, where the environment may comprise the operating conditions, such as what the temperature is in a rack or cabinet, if there is any cooling in the area etc. It is also possible that the value of the age dependent failure probability function is adjusted based on which axillary resources, if any, the cloud computing resource uses. These are just some ways in which the probability curve of the resource may be adjusted in order to obtain the primary fault probability of the cloud computing resource.

The cloud computing resource assigning unit 36 then assigns the cloud computing resources to the processes PR₁, PR₂, PR₃, PR₄ based on the process priorities, step 42, where processes with the highest process priorities are assigned to the cloud computing resources having the lowest primary failure probabilities. This means that a resource having a very high availability requirement may receive the resources having the lowest primary failure probability.

If the first process PR₁ is run by a voice media handling node, the tasks of this process could for instance be scheduled onto hardware that is considered to currently be at low risk of failure, whereas if the forth process PR₄ is run by a common web server with a best effort service level agreement, the tasks of this process could be scheduled onto hardware that has never before been powered up or onto a processing blade with a local SSD disk that is close to failure.

In this way the meeting of the availability requirement of the SLAs may be met while at the same time ensuring a more efficient use of the cloud computing resources. There is thus a good utilization of hardware while taking into account of the risk of failure and sensitivity of application.

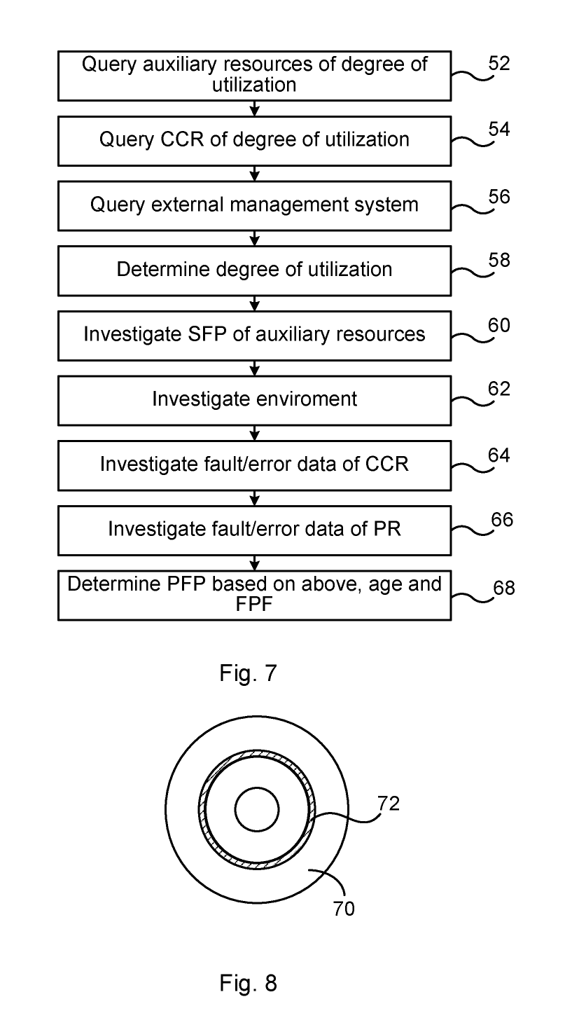

Now a second embodiment will be described with reference being made to FIGS. 6 and 7, where FIG. 6 shows a flow chart of method steps in the method for allocating physical cloud computing resources and FIG. 7 schematically shows a number of method steps being performed by the cloud computing resource allocation arrangement for determining primary fault probabilities associated with the cloud computing resources.

In this embodiment, the primary fault probability determining unit 32 keeps an inventory with primary fault probability functions for determining primary fault probability for each of the processing resources or cloud computing resources, where the primary fault probability is based on the age of the resource through being based on the age dependent failure probability function. There is thus, just as in the first embodiment, a primary fault probability that is based on the fault curve or MTBF curve and the age of the resource. However, in this embodiment there are further determinations being made in order to obtain a primary fault probability that better reflects the risk of failure.

For each hardware in the inventory there is thus an associated MTBF profile or fault probability function. This MTBF profile could be augmented with dynamic calculations taking into account environmental aspects and utilization aspects. Furthermore in the inventory there may be fault probability functions for both the cloud computing resources and the auxiliary resources.

As in the first embodiment, a number of processing requests for performing computational tasks are again being received in relation to the processes PR₁, PR₂, PR₃ and PR₄, step 44. The arrangement 26 may thus receive requests for processing from the first process PR₁, from the second process PR₂, from the third process PR₃ and from the fourth process PR₄. As before the requests are to be handled according to different SLAs and therefore the processes have different process priorities. The processing requests may be received by the primary fault probability determining unit 32. As an alternative they may be received by the availability investigating unit 34. In this second embodiment they are received by the primary fault probability determining unit 32.

Thereafter the primary fault probability determining unit 32 goes on and determines primary fault probabilities of the different resources, step 46. The primary failure probability of each cloud computing resource is determined based on the age and the failure probability function. The primary fault probabilities are thus based on the fault probabilities p_{MTTR} of the fault probability functions. After having determined these for the various cloud computing resources, the primary fault probability determining unit 32 informs the cloud computing resource assigning unit 36 of the primary fault probabilities of the individual cloud computing resources.

Furthermore, the availability investigating unit 34 investigates the availability of the cloud computing resources for performing the tasks of the requests, step 48. This may involve investigating which of the cloud computing resources of either the first and/or the second type are busy and which are free to receive a task. This may again be done through the availability investigating unit 34 querying the individual cloud computing resources and receiving responses. It may also be done through monitoring the activity of the processors the resources with regard to processor load and determining that a processor is available if the processor load is below a processor load threshold.

Thereafter, the cloud computing resource assigning unit 36 assigns the cloud computing resources to the processes PR₁, PR₂, PR₃, PR₄ based on the process priorities, step 50, where processes with the highest process priorities are assigned to the cloud computing resources having the lowest primary failure probabilities. This means that a resource having a very high availability requirement may receive the resources having the lowest failure probability.

In the assigning of resources it may be better to “close to ruin” one single cloud computing resource quickly rather than spread the load out over multiple resources. It may thus be advantageous to assign the process with lowest priority, which may be a non-critical process, to a cloud processing resource having the highest primary failure probability. If for instance the second primary cloud computing resource 16 has the highest primary failure probability, then it may be desirable to assign it to the fourth process PR₄ having the lowest priority. This could be of interest in relation to SSD disks where prices continuously fall and the longer you can postpone mass replacement of all SSD disks the lower the replacement price will be while at the same time ensuring that many disks are still unlikely to fail (and just to clarify: the processing on behalf of the non-critical process may be able to run for a long time before the disk fails completely). The requesting process having the lowest process priority may be assigned a single cloud computing resource having the highest primary faulty probability.

The way the primary fault probabilities are determined may, as was mentioned above, be based on more inputs than the fault probability of the fault probability function p_{MTTR}. The primary fault probabilities may for instance have a dependency on the extent of their use. The primary failure probability of a cloud computing resource may thus be based on the degree of utilization of the cloud computing resource. A cloud computing resource that is used a lot may for instance be more likely to become faulty than a physical resource used more infrequently. For this reason the primary fault probability determining unit 32 may query the auxiliary resources of the degree of utilization by various cloud computing resources, step 52. It may for instance send such queries to the switch 20, the NAS 20 and SAN 24. The utilization of a device could for instance be probed using mechanisms like Self-Monitoring, Analysis and Reporting Technology (SMART) commands.

The auxiliary devices may then respond with data of which processing resources have used them, where the degree of utilization may be estimated based on the response.

The primary fault probability determining unit 32 may also query the cloud processing resources of the degree of utilization, step 54. The utilization could also here be probed using mechanisms like SMART commands. It is also possible to use Intelligent Platform Management Interface (IPMI) commands to get fan runtimes at different speeds, power on cycles as well as hours in utilization.

The primary fault probability determining unit 32 may also query external management systems, step 56. It may for instance look at external logs or databases. The degree of utilisation may then be estimated based on the response.

It may also be possible to import hardware utilization data when installing a piece of hardware—e.g. after it comes back from repairs where counters may have been zeroed or when using estimation of utilization uptime.

Based on all or some of these inputs the primary failure determining unit 32 then determines or estimates the degree of utilization of each of the cloud computing resources, step 58. This degree of usage may then receive a corresponding usage fault probability pᵤ.

The primary fault probability determining unit 32 may also investigate the directory for the secondary fault probabilities of the auxiliary device, step 60. Also these may be associated with U- or bathtub curves and the values of the auxiliary devices used by every cloud computing resource may be considered. At least some of the cloud computing resources employ auxiliary resources for their performing of computational tasks, and the primary fault probability determining unit 32 may consider the secondary failure probabilities SFP of these used auxiliary resources in determining the primary failure probability of a cloud computing resource.

The primary fault probabilities may thus be adjusted with the secondary probabilities associated with the devices that the cloud computing resources in question use. If the dependency topology is known (e.g. compute blades depends on network switches and power supply) an aggregate MTBF should be calculated and used.

If a cloud computing resource for instance uses the switch then a corresponding secondary fault probability p_{S1} may be used, if the NAS unit 22 is employed a corresponding secondary fault probability p_{S2} may be used and if the SAN unit 24 is to employ a corresponding secondary fault probability p_{S3} may be used.

The primary fault probability determining unit 32 may furthermore investigate the physical environment of each cloud computing resource, step 62. It may therefore obtain environmental data such as temperature, humidity, vibrational data, or power supply data, for instance power supply data indicating if there are unclean power spikes etc. As power saving on cooling brings the temperature up in server rooms the probability model for errors may take into account location in datacentre and position in a rack or cabinet to take account for different environmental aspects. The primary fault determining unit 32 may therefore also provide an environmental fault probability pₑ for each cloud computing resource in order to base the primary failure probability also on the physical environment.

If as an example the first cabinet 11 has a better environment, for instance if the temperature is lower there than in the second cabinet 14, the cloud computing resources in this first cabinet 11 will have a lower environmental fault probability than the cloud computing resources in the second cabinet 14. In this example the resource 12 will thus have a lower environmental fault probability than the resource 16.

The primary fault probability determining unit 32 may also investigate fault & error data of the cloud computing resources, step 64. The system can also include heuristic information—“borderline hardware” that is known to e.g. spontaneously reboot from time to time due to memory errors or similar or even a whole site that is prone to power outages. The primary fault determining unit 32 may therefore also provide a fault dependent fault probability p_{f} that depends on how error prone the physical resource is in order to let the primary failure probability of a cloud computing resource to be based on fault and error data associated with the cloud computing resource.

The primary fault determining unit 32 may also investigate the fault error data of the processes, step 66. MTTR for the application could be heuristically determined from normal events of starting the application and storing these or explicitly included in the application descriptor read by the cloud management system. IT may thus also provide a process dependent fault dependent fault probability pₚ in order to obtain a primary failure probability of a cloud computing resource that is also based on fault and error data of a requesting process.

Based on all or some of this input it is then possible for the primary fault determining unit 32 to determine an aggregate primary fault probability pₜₒₜ for all or some of the above-mentioned probabilities as well as based on the age, step 68, and more particularly based on the fault probability p_{MTTR} of the fault probability function for this the age.

For a cloud computing resource of the first type that uses both the NAS 22 and SAN 24 via the switch 20, the primary fault probability may for instance be set as:

Pₜₒₜ=pᵤ+pₑ+p_{S1}+p_{S2}+p_{S3}+p_{f}+pₚ+p_{MTTR}

Here it may be seen that the corresponding primary fault probability for a cloud computing resource of the second type may be set as:

Pₜₒₜ=pᵤ+pₑ+p_{f}+pₚ+p_{MTTR}

Although it is not shown above, it should be realized that it is possible to use weights in the equations. It is also possible that one or more of the probability values above are combined in other ways. Some, for instance the secondary probabilities and the probability of the age dependent probability function may for instance be multiplied with each other.

It may furthermore be of interest to only use one or a few of the further probabilities. As an example the process dependent fault dependent fault probability pₚ may be omitted.

The above described arrangement has a number of advantages. It provides a good balance between meeting the various reliability requirements of the processes and efficient use of the physical resources. In this way the risk of failing to meet contractual obligations is lowered combined with a good usage of equipment, which may be advantageous from a maintenance point of view.

As mentioned above the process priority of a process may consider the sensitivity to security. This means that, the sensitive data of a task or virtual machine is not allowed to remain on a physical resource after the task or processing is finished. When the cloud computing resource is functioning it can be securely wiped/cleaned. However, if the resource breaks down during processing, this is not possible. If this happens security personnel would have to rush out to the data centre 10, lift out and destroy the hardware. Through having this sensitivity reflected in the process priority, the risk of having to perform such drastic measures are lowered.

The cloud computing resource allocation arrangement 26 may, as was implied initially, be provided in the form one or more processors with associated program memories comprising computer program code with computer program instructions executable by the processor for performing the functionality of the cloud computing resource allocation arrangement.

The computer program code of a cloud computing resource allocation arrangement may also be in the form of computer program product for instance in the form of a data carrier, such as a CD ROM disc or a memory stick. In this case the data carrier or memory stick carries a computer program with the computer program code, which will implement the functionality of the above-described cloud computing resource allocation arrangement. One such data carrier 70 with computer program code 72 is schematically shown in FIG. 8.

Furthermore the cloud computing resource allocation arrangement may be seen as comprising means for receiving requests for performing computational tasks from a number of processes, where the means for receiving may be implemented through the primary fault probability determination unit or the availability investigating unit.

The availability investigating unit may furthermore be considered to form means for investigating the availability of the cloud computing resources for performing the tasks of the requests.

The cloud computing resource assigning unit may in turn be considered to form means for assigning the available cloud computing resources to the processes based on the process priorities.

The primary fault probability determination unit may further be considered to form means for determining the primary failure probability of each cloud computing resource based on the age and the failure probability function. The primary fault probability determination unit may furthermore be considered to form means for considering secondary failure probabilities of used auxiliary resources in determining the primary failure probability of a cloud computing resource. The primary fault probability determination unit may furthermore be considered to form means for determining the primary failure probability of a cloud computing resource based on the degree of utilization of the cloud computing resource. The primary fault probability determination unit may furthermore be considered to form means for querying auxiliary resources of the degree of utilization by the cloud computing resource and estimate the degree of utilization based on the response. The primary fault probability determination unit may furthermore be considered to form means for querying a cloud computing resource about data indicative of the utilization and estimate the degree of utilization based on the response. The primary fault probability determination unit may further be considered to form means for querying an external management system and estimating the degree of utilisation based on the response. The primary fault probability determination unit may furthermore be considered to form means for determining the primary failure probability of a cloud computing resource based on the physical environment of the cloud computing resource. The primary fault probability determination unit may furthermore be considered to form means for determining the primary failure probability of a cloud computing resource based on fault and error data associated with the cloud computing resource. The primary fault probability determination unit may furthermore be considered to form means for determining the primary failure probability of a cloud computing resource based on fault and error data of a requesting process.

Finally the cloud computing resource assigning unit may be considered to form means for assigning the requesting process having the lowest process priority a single cloud computing resource having the highest primary faulty probability.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. An arrangement for allocating physical cloud computing resources to processes, where at least some of the cloud computing resources have different ages, said cloud computing resources having individual primary failure probabilities, each being based on an age dependent failure probability function of the cloud computing resource, the arrangement comprising a processor acting on computer instructions whereby said arrangement is operative to:
receive requests for performing computational tasks for a number of processes, said processes having different process priorities;
investigate the availability of the cloud computing resources for performing the tasks of the requests; and
assign the available cloud computing resources to the processes based on the process priorities, where processes with the highest process priorities are assigned to the cloud computing resources having the lowest primary failure probabilities.

2. The arrangement according to claim 1, further operative to determine the primary failure probability of each cloud computing resource based on the age and the failure probability function.

3. The arrangement according to claim 2, wherein at least some of the cloud computing resources employ auxiliary resources for their performing of computational tasks, and the arrangement is further operative to consider secondary failure probabilities of used auxiliary resources in determining the primary failure probability of a cloud computing resource.

4. The arrangement according to claim 2, wherein the primary failure probability of a cloud computing resource is based on the degree of utilization of the cloud computing resource.

5. The arrangement according to claim 4, wherein at least some of the cloud computing resources employ auxiliary resources for performing computational tasks and the arrangement is further operative to query auxiliary resources of the degree of utilization by a cloud computing resource and estimate the degree of utilization based on the response.

6. The arrangement according to claim 4, being further operative to query a cloud computing resource about data indicative of the utilization and estimate the degree of utilization based on the response.

7. The arrangement according to claim 4, being further operative to query an external management system and estimate the degree of utilisation based on the response.

8. The arrangement according to claim 2, wherein the primary failure probability of a cloud computing resource is based on the physical environment of the cloud computing resource.

10. The arrangement according to claim 2, wherein the primary failure probability of a cloud computing resource is based on fault and error data associated with the cloud computing resource.

11. The arrangement according to claim 2, wherein the primary failure probability of a cloud computing resource is based on fault and error data of a requesting process.

12. The arrangement according to claim 11, wherein the requesting process having the lowest process priority is assigned a single cloud computing resource having the highest primary faulty probability.

13. A method for allocating physical cloud computing resources to processes, where at least some of the cloud computing resources have different ages, said cloud computing resources having individual primary failure probabilities, each being based on an age dependent failure probability function of the cloud computing resource, the method being performed in a cloud computing resource allocating arrangement and comprising:
receiving requests for performing computational tasks for a number of processes, said processes having different process priorities;
investigating the availability of the cloud computing resources for performing the tasks of the requests; and
assigning the available cloud computing resources to the processes based on the process priorities, where processes with the highest process priorities are assigned to the cloud computing resources having the lowest primary failure probabilities.

14. The method according to claim 13, further comprising determining the primary failure probability of each cloud computing resource based on the age and the failure probability function.

15. The method according to claim 14, wherein at least some of the cloud computing resources employ auxiliary resources for their performing of computational tasks, the method further comprising considering secondary failure probabilities of used auxiliary resources in the determining of the primary failure probability of a cloud computing resource.

16. The method according to claim 14, wherein the primary failure probability of a cloud computing resource is based on the degree of utilization of the cloud computing resource.

17. The method according to claim 14, wherein the primary failure probability of a cloud computing resource is based on the physical environment of the cloud computing resource.

18. The method according to claim 14, wherein the primary failure probability of a cloud computing resource is based on fault and error data associated with the cloud computing resource.

19. (canceled)

20. (canceled)

21. A computer program for allocating physical cloud computing resources to processes, where at least some of the cloud computing resources have different ages, said cloud computing resources having individual primary failure probabilities, each being based on an age dependent failure probability function of the cloud computing resource, the computer program comprising computer program code which when run in an arrangement program comprising computer program code which when run in an arrangement for allocating cloud computing resources, causes the arrangement to:
receive requests for performing computational tasks for a number of processes, said processes having different process priorities
investigate the availability of the cloud computing resources for performing the tasks of the requests; and
assign the available cloud computing resources to the processes based on the process priorities, where processes with the highest process priorities are assigned to the cloud computing resources having the lowest primary failure probabilities.

22. A computer program product for allocating physical cloud computing resources to processes, the computer program product comprising a non-transitory data carrier with computer program code according to claim 21.
